(19) United States
(12) Patent Application Publication
(10) Pub. No.: US 2004/0145858 A1
(43) Pub. Date: Jul. 29, 2004

(54) Multilayer circuit board, manufacturing method therefor, electronic device, and electronic apparatus

(76) Inventor: Kazuaki Sakurada, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/713,572

(22) Filed: Nov. 12, 2003

(30) Foreign Application Priority Data
Nov. 19, 2002 (JP) 2002-334915
Aug. 25, 2003 (JP) 2003-300143

(51) Int. Cl. B05D 5/12; H02B 1/00

(52) U.S. Cl. 361/600; 427/96

(57) ABSTRACT

A multilayer circuit board and a manufacturing method for producing the board via simple manufacturing processes employing a droplet jetting method, where the inter-layer insulating film can be easily made flat. The multilayer circuit board includes at least two wiring layers, an inter-layer insulating film provided between every adjacent two of the wiring layers, and conductive posts for providing electrical conductivity between the wiring layers. The manufacturing method includes the step of forming the inter-layer insulating film by changing the film thickness of the inter-layer insulating film according to a concavo-convex shape of an area where the inter-layer insulating film is formed, so as to level an upper surface of the inter-layer insulating film. The concavo-convex shape may be computed based on design data of a circuit pattern for forming the wiring layers and the conductive posts, or may be measured before the inter-layer insulating film is formed.

### BACKGROUND OF THE INVENTION

1. Field of the Invention

The present invention relates to multilayer circuit boards, manufacturing methods therefor, electronic devices, and electronic apparatuses.

Priority is claimed on Japanese Patent Applications, No. 2002-334915, filed Nov. 19, 2002, and No. 2003-300143, filed Aug. 25, 2003, the contents of which are incorporated herein by reference.

2. Description of the Related Art

Conventionally, the inter-layer insulating film used in the multilayer printed circuit board is generally produced by a spin coating method or a roll coating method. In the spin coating method, after a liquid material is dropped onto a substrate, the substrate is spun so as to coat the entire surface of the substrate with the liquid material and to form an insulating film. In the roll coating method, a solvent film is transferred onto a roll. However, in the spin coating method, the efficiency of actually using the material is approximately 10%, and an additional process, such as cleaning of the back face, is necessary. The roll coating method is highly efficient in using material, but has a problem of contamination of foreign material from the transfer roll.

Recently, an inkjet method has been developed to produce such an inter-layer insulating film for the multilayer printed circuit board. This method uses a droplet jetting technique which is well known in the field of inkjet printers, and in which droplets of ink material, that is, liquid material for forming the inter-layer insulating film, are jetted onto a substrate and are fixed. According to such an inkjet method, each ink droplet of the ink material is accurately jetted onto a minute area so that the ink material can be directly fixed onto a desired area. Therefore, the ink material is not wasted and the manufacturing cost can be reduced. Therefore, this method is very reasonable.

However, in the prior art, the substrate is coated with the material which is equally jetted from the material jetting nozzle. Therefore, the inter-layer insulating film is formed conforming to uneven circuit patterns in the wiring layer, and the evenness of the inter-layer insulating film is insufficient. With such an uneven inter-layer insulating film, the section of an upper layer from the inter-layer insulating film is also uneven; thus, an even wiring layer cannot be formed. In addition, the section shape of a further upper inter-layer insulating film or wiring layer is also influenced, thereby causing disconnection between wiring layers. If the substrate is rotated, the efficiency of using material is reduced, and an additional process such as cleaning of the back face is necessary.

### SUMMARY OF THE INVENTION

In consideration of the above circumstances, an object of the present invention is to provide a manufacturing method for producing a fine multilayer circuit board via relatively simple manufacturing processes employing a droplet jetting method, where the inter-layer insulating film for the circuit board can be easily made flat. The present invention also provides a multilayer circuit board, electronic device, and electronic apparatus.

Therefore, the present invention provides a manufacturing method of a multilayer circuit board, comprising the step of forming at least two wiring layers, an inter-layer insulating film provided between every adjacent two of the wiring layers, and conductive posts for providing electrical conductivity between the wiring layers, wherein:

said step includes forming the inter-layer insulating film by changing the film thickness of the inter-layer insulating film according to a concavo-convex shape of an area where the inter-layer insulating film is formed, so as to level an upper surface of the inter-layer insulating film.

In this method, a droplet jetting method is preferably used.

A typical example of the above method will be explained by employing a multilayer circuit board in which a substrate, the first wiring layer, conductive posts, an inter-layer insulating film, and the second wiring layer are stacked in turn.

First, the first wiring layer having a specific circuit pattern is formed on the substrate. A section of the circuit pattern on the substrate includes concave portions produced by steps between the portions where wiring is formed and the remaining portions. This first wiring layer can be formed by a method such as photolithography, and preferably, by the droplet jetting method.

In the next step, the conductive posts are formed on the first wiring layer. A section of the conductive posts on the first wiring layer includes convex portions formed by the first wiring layer and the protruding conductive posts on this layer. Preferably, the conductive posts are formed by the droplet jetting method.

The above concave portions and the convex portions are collectively called the concavo-convex portions having the “concavo-convex shape” of the present invention, that is, the concavo-convex portions mean steps or protruding portions with respect to a desired flat surface.

In the next step, the inter-layer insulating film is formed according to the concavo-convex shape of an area where the inter-layer insulating film is formed, so as to level the upper surface of the inter-layer insulating film. Here, the area where the inter-layer insulating film is formed is surrounded by at least the substrate, the first wiring layer, and the conductive posts, and “forming the inter-layer insulating film according to the concavo-convex shape” specifically means to jet a larger amount of ink material (for the inter-layer insulating film) toward the concave portions of the concavo-convex portion and to jet a smaller amount of ink material toward the convex portions.

In the next step, the second wiring layer having a specific circuit pattern is formed on the inter-layer insulating film. Accordingly, the first wiring layer and the second wiring layer are connected via the conductive posts. As the upper surface of the inter-layer insulating film is flat, the film thickness of the second wiring layer formed on the surface of the inter-layer insulating film is uniform and the upper surface of the second wiring layer is also flat. Preferably, the second wiring layer is also produced by the droplet jetting method.

When the inter-layer insulating film is produced by the droplet jetting method, the manufacturing method for the multilayer circuit board includes a drying step of driving off a liquid component which is included in the ink material and which can be evaporated or can volatilize.

According to the present invention, the upper surface of the inter-layer insulating film can be made flat, thereby making the film thickness of the second wiring layer uniform, so that preferable insulation performance can be provided between the first and second wiring layers, and disconnection between the wiring layers can be avoided. In addition, even upper layers (i.e., third, fourth, etc., wiring layers or inter-layer insulating films) from the second wiring layer which is formed on the flat upper surface of the inter-layer insulating film can easily have flat upper surfaces and uniform film thickness.

The concavo-convex shape of the area where the inter-layer insulating film is formed may be computed based on design data of a circuit pattern for forming the wiring layers and the conductive posts. The design data include (i) electronic data for forming the wiring layer and the conductive posts by the droplet jetting method based on a specific circuit pattern, and (ii) set values such as the jetted amount of each droplet, the arrangement of droplets, the number of times the jetting step is performed, etc., in the droplet jetting method. Preferably, the format of the electronic data is bit-map-pattern format, or DXF or DWG format used in CAD (computer aided design).

When the wiring layer and the conductive posts are formed by photolithography, electronic data including an electronic mask pattern used in the exposure step may be used.

According to the present invention, the shape of the area where the inter-layer insulating film is formed can be computed in advance based on design data of the circuit pattern, and the inter-layer insulating film is formed according to the computed results; thus, the inter-layer insulating film can be efficiently formed.

The concavo-convex shape of the area where the inter-layer insulating film is formed may be measured before the inter-layer insulating film is formed.

Typically, the measurement of the concavo-convex shape is performed in advance (i.e., before the inter-layer insulating film is formed) for the entire area where the inter-layer insulating film is formed (i.e., the insulating film formation area), and the dimension for the concavo-convex shape is accurately measured as three-dimensional data (i.e., measurement data) by using a contactless step measurement device. Based on the three-dimensional data, image analysis or the like is performed so as to compute the insulating film formation area, thereby determining an optimum jetted amount, droplet arrangement, number of times the jetting operation is performed, etc., of the ink material, which is jetted toward the insulating film formation area. The droplet jetting is performed under the determined conditions. Specifically, a larger amount of ink material is jetted toward deeper concave portions while a smaller amount of ink material is jetted toward shallower concave portions.

As the contactless step measurement device, a step measurement device using optical interference (e.g., a laser step measurement device) or a scanner is preferably used.

The measurement of the concavo-convex shape may be performed using a head-preceding sensor. The head-preceding sensor is positioned in the vicinity of the droplet jetting head of the droplet jetting apparatus. According to the head-preceding sensor, the step measurement for the concavo-convex shape and the droplet jetting using the droplet jetting head are performed in parallel, where the droplet jetting is performed based on the measurement data of the concavo-convex shape. Specifically, a larger amount of ink material is jetted toward deeper concave portions while a smaller amount of ink material is jetted toward shallower concave portions.

According to the present invention, when the contactless step measurement device is used, the inter-layer insulating film can be formed in the insulating film formation area which has been computed based on the accurately measured three-dimensional data (i.e., the measurement data). When the head-preceding sensor is employed, measurement of the entire area where the inter-layer insulating film is formed is unnecessary, and step measurement for the concave portions and the droplet jetting can be efficiently performed.

According to either method (for measuring the concavo-convex shape) explained above, the actual shape including a dimensional error in the concavo-convex portions (i.e., an error between the design data and the measurement data) is measured. Therefore, in comparison with the inter-layer insulating film formed based on the design data, the inter-layer insulating film formed according to the actual measurement data can be made more accurately level.

In a typical example of the manufacturing method, the step of forming the inter-layer insulating film includes forming a plurality of the inter-layer insulating films which are stacked in turn, and this step includes the steps of:

forming the first inter-layer insulating film having a film thickness which is predetermined according to the concavo-convex shape of the area where the inter-layer insulating film is formed, where the concavo-convex shape is computed by design data of a circuit pattern for forming the wiring layers and the conductive posts; and

measuring steps in an upper surface of the first inter-layer insulating film and forming the second inter-layer insulating film in a manner such that concave portions in the steps are filled with the second inter-layer insulating film.

The first inter-layer insulating film is a layer film which is first formed on the insulating film formation area, and the second inter-layer insulating film is a layer film formed on the first inter-layer insulating film which is produced in advance. If the third, fourth, etc., inter-layer insulating films are formed, these are also layer films formed on the inter-layer insulating film which is produced in advance; thus, these films are collectively called the second inter-layer insulating film. In addition, “measuring steps in an upper surface of the first inter-layer insulating film” typically means measurement using the above-explained contactless step measurement device.

According to the present invention, the shape of the insulating film formation area is computed in advance based on the design data of the circuit pattern, and the inter-layer insulating film is formed according to the computed results. Therefore, the first inter-layer insulating film can be efficiently produced.

In addition, steps in the upper surface of the first inter-layer insulating film are measured, so that the actual steps in consideration of errors in the film thickness and the flatness of the first inter-layer insulating film can be measured.

The second inter-layer insulating film is formed so as to fill the concave portions in the steps, so that the upper surface of the inter-layer insulating film can be flat. Therefore, the upper surface of the first inter-layer insulating film can be relatively roughly formed in comparison with the second inter-layer insulating film; thus, it is possible to form the first inter-layer insulating film by which the time necessary for the droplet jetting method can be reduced.

In addition, the first inter-layer insulating films and the second inter-layer insulating film are separately formed; thus, the film thickness of the inter-layer insulating film can be more easily controlled in comparison with the method for forming a desired inter-layer insulating film at one time, thereby forming an accurately-flat upper surface of the inter-layer insulating film.

In the above method, the inter-layer insulating film is preferably formed by using a droplet jetting method; and the first inter-layer insulating film may be formed by jetting relatively large droplets from a droplet jetting head, and the second inter-layer insulating film may be formed by jetting droplets, which are smaller than said relatively large droplets, from the droplet jetting head.

According to this method, the first inter-layer insulating film is formed at a specific jetting accuracy, and the second inter-layer insulating film is formed at a higher jetting accuracy. Therefore, in addition to the above-explained effects obtained by the manufacturing method of the present invention, the inter-layer insulating film can have a more accurate flat surface.

When the manufacturing method of the present invention uses a droplet jetting method, the amount of ink material jetted per unit area may be controlled by adjusting the amount jetted per droplet of the ink material, where the amount jetted per droplet is changed by controlling a driving waveform for a droplet jetting head.

Generally, the droplet jetting head has a pressure generation chamber which communicates with nozzle holes, and a pressure generating element for pressurizing a liquid material in the pressure generation chamber so as to jet ink material through the nozzle holes. The driving waveform is a waveform of the voltage which is applied to the pressure generating element. The amount of ink material jetted per unit area means the amount of ink material jetted per unit area of the insulating film formation area. The ink material corresponds to a liquid material obtained by incorporating a material for the inter-layer insulating film into a liquid which can be evaporated or can volatilize. The liquid material may be a solution obtained by dissolving the material for the inter-layer insulating film in a solvent, or a solution obtained by dispersing the material in a liquid. In the latter case, the material for the inter-layer insulating film may be fine particles or ground particles. Any other method which can be applied to the droplet jetting method may also be employed so as to obtain a liquid material.

According to the present invention, a desired voltage is applied to the pressure generating element by controlling the driving waveform, and the ink material in the pressure generation chamber is pressurized by the pressure generating element, so that a suitable amount of the ink material is jetted through the nozzle holes and thus the amount of the ink material jetted per unit area of the insulating film formation area can be adjusted.

If the driving waveform is set so that a higher voltage is applied to the pressure generating element, the amount jetted in each jetting operation can be larger, while if the driving waveform is set so that a lower voltage is applied to the pressure generating element, the amount jetted in each jetting operation can be smaller.

If the driving waveform is set so that the number of pulses per unit time of the voltage applied to the pressure generating element is larger, the amount jetted in each jetting operation can be larger, while if the driving waveform is set so that the number of pulses per unit time of this voltage is smaller, the amount jetted in each jetting operation can be smaller.

The voltage and the number of pulses with respect to the driving waveform can be suitably determined, thereby performing the droplet jetting under desired conditions.

In addition, when the manufacturing method of the present invention uses a droplet jetting method, the amount of ink material jetted per unit area may be controlled by adjusting distance intervals between positions where the ink material is jetted.

The distance intervals between positions where the ink material is jetted means distance data between at least two points where the ink material is jetted, and the distance intervals may be determined by controlling the amount of relative movement between the substrate and the droplet jetting head, or by controlling the jetting/non-jetting state of each of plural nozzles. Actually, the droplet jetting is performed during the relative movement, and the higher the relative movement speed, the larger the distance intervals, thereby sparsely arranging the jetted points of the ink material. Conversely, the lower the relative movement speed, the smaller the distance intervals, thereby closely arranging the jetted points of the ink material. For example, regarding the first case of jetting the ink material at intervals of 10 μm and the second case of jetting the ink material at intervals of 20 μm, the first case has an amount jetted per unit area which is twice as much as that of the second case. If droplet jetting is performed at the same point without performing the relative movement, so-called double coating can be performed.

When the jetting/non-jetting state of each nozzle is controlled in a specified area, the first case of performing the jetting 50 times has a sparser arrangement in comparison with the second case of performing the jetting 100 times, and the first case has an amount jetted per unit area which is half as much as that of the second case.

According to the present invention, the distance intervals between positions where the ink material is jetted is controlled so that close/sparse arrangement conditions for the ink material can be adjusted, thereby adjusting the amount jetted per unit area of the insulating film formation area.

The present invention also provides a multilayer circuit board comprising:

at least two wiring layers,

an inter-layer insulating film provided between every adjacent two of the wiring layers, which is formed by changing the film thickness of the inter-layer insulating film according to a concavo-convex shape of an area where the inter-layer insulating film is formed, so as to level an upper surface of the inter-layer insulating film; and

conductive posts for providing electrical conductivity between the wiring layers.

According to the present invention, effects similar to those obtained by the above-explained manufacturing method can be obtained, and a multilayer circuit board having preferable insulation performance between the wiring layers can be produced.

The present invention also provides an electronic apparatus comprising a multilayer circuit board as explained above. In this case, effects similar to those obtained by the multilayer circuit board can be obtained, and an electronic apparatus which is resistant to dielectric breakdown can be produced.

The present invention also provides an electronic device comprising:

at least two wiring layers,

an inter-layer insulating film provided between every adjacent two of the wiring layers, which is formed by changing the film thickness of the inter-layer insulating film according to a concavo-convex shape of an area where the inter-layer insulating film is formed, so as to level an upper surface of the inter-layer insulating film; and

conductive posts for providing electrical conductivity between the wiring layers.

According to the present invention, effects similar to those obtained by the above-explained manufacturing method can be obtained, and an electronic device having preferable insulation performance between the wiring layers can be produced.

The present invention also provides an electronic apparatus comprising an electronic device as explained above. In this case, effects similar to those obtained by the electronic device can be obtained, and an electronic apparatus which is resistant to dielectric breakdown can be produced.

### BRIEF DESCRIPTION OF THE DRAWINGS

FIGS. 1A to 1H are diagrams showing processes of the manufacturing method of the multilayer circuit board in the first embodiment according to the present invention.

FIGS. 2A to 2H are also diagrams showing processes of the manufacturing method of the multilayer circuit board in the first embodiment.

FIGS. 3A to 3C are also diagrams showing processes of the manufacturing method of the multilayer circuit board in the first embodiment.

FIGS. 4A and 4B are diagrams showing the droplet jetting apparatus used in the first embodiment, where FIG. 4A is a perspective view showing the general structure of the droplet jetting apparatus, and FIG. 4B is a side sectional view showing main portions of the droplet jetting apparatus.

FIG. 5 is a diagram showing waveforms of the driving signal supplied to the piezoelectric element of the droplet jetting apparatus in the first embodiment.

FIG. 6 is a diagram showing a process of the manufacturing method of the multilayer circuit board in the second embodiment according to the present invention.

FIG. 7 is a diagram showing a process of the manufacturing method of the multilayer circuit board in a variation of the second embodiment.

FIGS. 8A to 8E are diagrams showing processes of the manufacturing method of the multilayer circuit board in the third embodiment according to the present invention.

FIGS. 9A and 9B are diagrams showing processes of the manufacturing method of the multilayer circuit board in the fourth embodiment according to the present invention.

FIGS. 10A to 10D are diagrams showing processes of the manufacturing method of the multilayer circuit board in the fifth embodiment according to the present invention.

FIGS. 11A to 11F are diagrams showing processes of the manufacturing method of the multilayer circuit board in the sixth embodiment according to the present invention.

FIGS. 12A and 12B are diagrams for explaining the TFT substrate in the LCD device in the seventh embodiment according to the present invention, where FIG. 12A shows an equivalent circuit and FIG. 12B is a partially-enlarged view showing a main portion of the TFT substrate.

FIG. 13 is a side sectional view showing OLED, a portion of which is produced by the manufacturing method of the multilayer circuit board in the eighth embodiment according to the present invention.

FIG. 14 is a perspective view showing an example of the electronic apparatus which includes a multilayer circuit board and an LCD device in the ninth embodiment according to the present invention.

FIG. 15 is a perspective view showing another example of the electronic apparatus which includes a multilayer circuit board and an LCD device in the ninth embodiment.

FIG. 16 is a perspective view showing another example of the electronic apparatus which includes a multilayer circuit board and an LCD device in the ninth embodiment.

### DESCRIPTION OF THE PREFERRED EMBODIMENTS

Hereinafter, embodiments of the manufacturing method of the multilayer circuit board according to the present invention will be explained with reference to the drawings.

First Embodiment

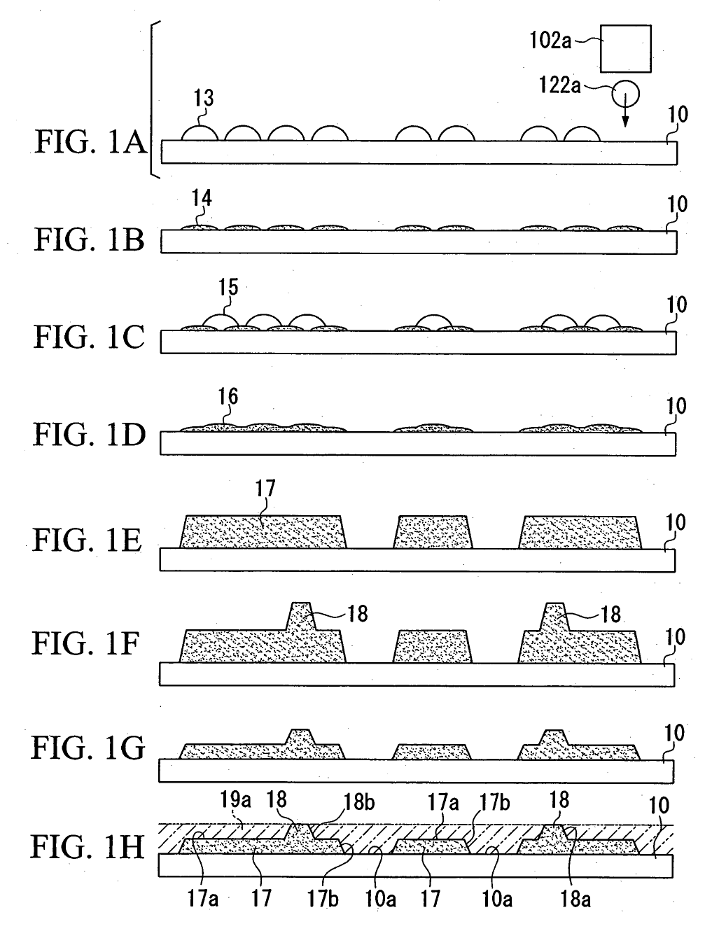

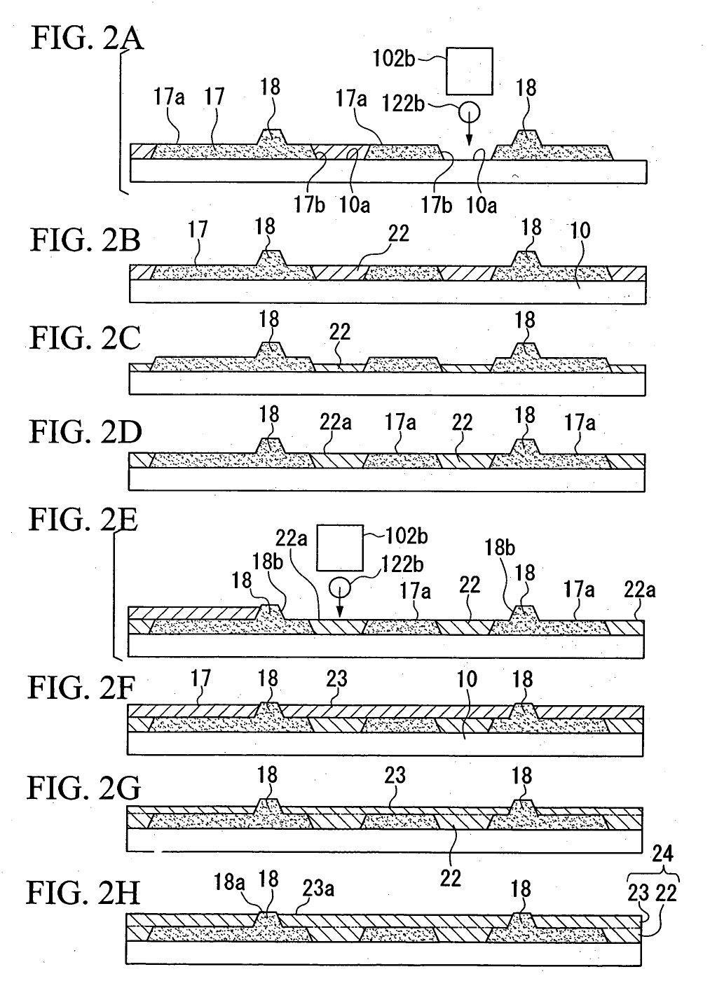

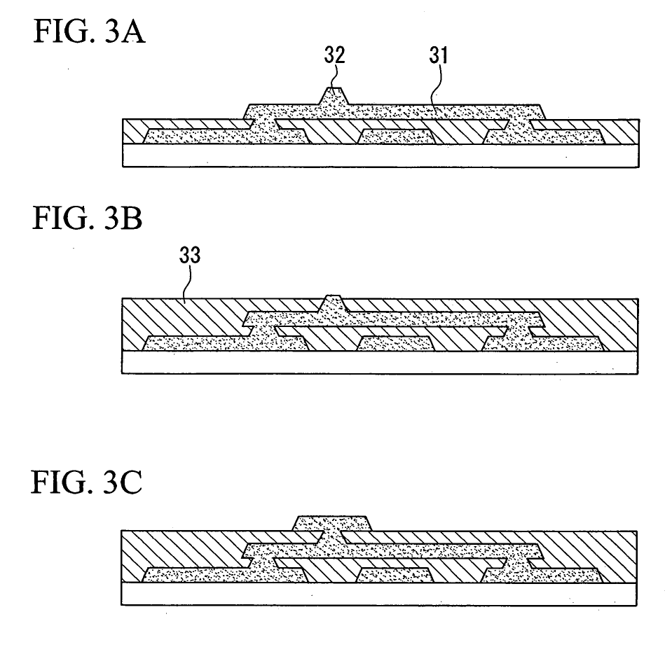

FIGS. 1A to 3C are diagrams showing the processes of the manufacturing method of the multilayer circuit board in the first embodiment of the present invention. FIGS. 1A to 1H show processes from the ink-repellent coating process to the process of forming the first circuit pattern (i.e., the first wiring layer) and the inter-layer conductive posts. FIGS. 2A to 2H show the process of forming the first inter-layer insulating film. FIGS. 3A to 3C show the processes of forming the second circuit pattern (i.e., the second wiring layer), the second inter-layer insulating film, and the third circuit pattern (i.e., the third wiring layer). In the present embodiment, multilayer printed wiring is formed on one of the faces of the substrate 10.

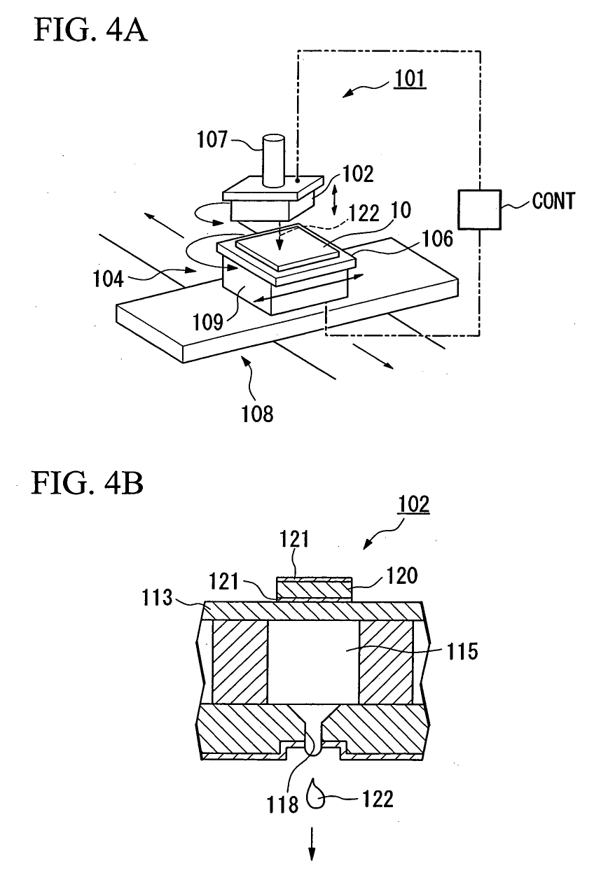

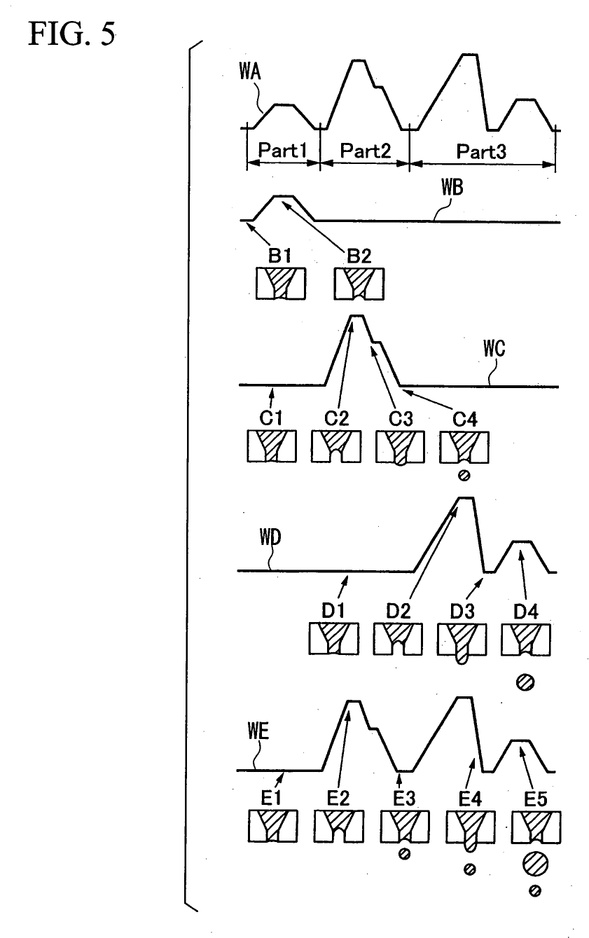

FIGS. 4A and 4B are diagrams showing the droplet jetting apparatus used in the manufacturing method of the multilayer circuit board. FIG. 4A is a perspective view showing the general structure of the droplet jetting apparatus, and FIG. 4B is a side sectional view showing main portions of the droplet jetting apparatus. FIG. 5 is a diagram showing waveforms of the driving signal supplied to the piezoelectric element of the droplet jetting apparatus.

Droplet Jetting Apparatus

The droplet jetting apparatus 101 shown in FIG. 4A has an inkjet head 102 (i.e., a droplet jetting head) for jetting ink material 122 onto the substrate 10, a displacement mechanism 104 for displacing the relative position between the inkjet head 102 and the substrate 10, and a controller “CONT” for controlling the inkjet head 102 and the displacement mechanism 104.

The inkjet head 102 is used for jetting ink material 122 onto the substrate 10. As shown in FIG. 4B, this inkjet head 102 has a pressure generation chamber 115 which communicates with nozzle holes 118 (only one nozzle hole 118 is shown in FIG. 4B), and a piezoelectric element 120 (i.e., a pressure generating element) for pressurizing the ink material 122 in the pressure generation chamber 115 so as to jet the ink material 122 through the nozzle holes 118.

The displacement mechanism 104 includes a head supporting section 107 for supporting the inkjet head 102 which is positioned downward so as to face the substrate 10 which is disposed on a substrate stage 106. The displacement mechanism 104 also includes a stage driving section 108 for relatively moving the substrate stage 106 (i.e., moving the substrate 10) with respect to the inkjet head 102 (positioned above the substrate 10) in the X and Y directions.

In the inkjet head 102, the piezoelectric element 120 is positioned between a pair of electrodes 121. When being energized, the piezoelectric element 120 is bent in a manner such that the element projects outward. The diaphragm 113, to which the above piezoelectric element 120 is attached, is also bent outward together with the piezoelectric element 120, thereby increasing the volume of the pressure generation chamber 115. Therefore, a specific amount of the ink material 122, corresponding to the increased amount of volume of the pressure generation chamber 115, is drawn from a supply inlet (not shown) into the pressure generation chamber 115. After that, when the energization for the piezoelectric element 120 is released, original figures of the piezoelectric element 120 and the diaphragm 113 are restored. Accordingly, the original volume of the pressure generation chamber 115 is also restored, and the pressure of the ink material 122 in the pressure generation chamber 115 is increased, so that a droplet of the ink material 122 is jetted from each nozzle hole 118 toward the substrate.

The inkjet method of the inkjet head 102 is not limited to such a piezoelectric jetting method using the piezoelectric element 120. For example, a method using an electro-thermal conversion element which functions as an energy generation element may be employed.

The controller CONT includes a CPU such as a microprocessor for controlling the entire system of the apparatus, and a computer having input/output functions for various signals. As shown in FIG. 4A, the controller CONT is electrically connected to each of the inkjet head 102 and the displacement mechanism 104, thereby controlling at least one of (in the present embodiment, both of) the jetting operation of the inkjet head 102 and the displacement operation using the displacement mechanism 104. According to the above-explained structure, in the present system, the jetting condition is not fixed and the thickness of the film to be formed can be controlled.

That is, the controller CONT has the following control functions for controlling the amount of jetted ink material 122: a function of changing the jet distance interval on the substrate 10, a function of changing the amount of the ink material 122 jetted per droplet, a function of changing the angle θ between the direction along which the nozzle holes 118 are arranged and the direction of the displacement using the displacement mechanism 104, a function of determining the jet condition for each of repeated jetting operations toward the same position on the substrate 10, and a function of determining the jet condition for each divided area on the substrate 10. Here, the jet condition is determined by controlling the driving waveform for the voltage applied to the piezoelectric element 120.

As the control functions for changing the jet distance interval on the substrate 10, the controller CONT has a function of changing the relative movement speed between the substrate 10 and the inkjet head 102, a function of changing the time interval between the jetting operations during the relative movement, and a function of selecting some of the nozzle holes 118, from which the ink material 122 is jetted at the same time.

FIG. 5 shows examples of the driving signal supplied to the piezoelectric element 120 and corresponding states of the ink material 122 jetted from the nozzle hole 118 (see the shaded portion in each small diagram associated with reference symbols B1 to E5). Below, the principle of jetting the ink material 122 as three different types of dots, that is, a small (or minute) dot, a medium dot, and a large dot, will be explained with reference to FIG. 5.

In FIG. 5, the driving waveform WA is a basic waveform generated by a driving signal generation circuit. The waveform WB, formed during the section “Part 1” of the basic waveform, is used for oscillating a “meniscus” liquid surface (i.e., which is not flat) so as to diffuse the ink material 122 in the vicinity of the nozzle hole 118, whose viscosity has been increased, and to prevent insufficient jetting of a minute amount of the ink material 122. The small diagram associated with reference symbol B1 shows a state of a static meniscus surface, and the small diagram associated with reference symbol B2 explains the operation of slightly drawing the meniscus surface toward the inside of the nozzle hole 118 by generally charging the piezoelectric element 120 and increasing the volume of the pressure generation chamber 115.

The waveform WC, formed during the section “Part 2” of the basic waveform, is used for jetting a minute dot of the ink material 122. From the initial static state (see small diagram associated with reference symbol C1), the piezoelectric element 120 is suddenly charged so as to quickly draw a meniscus surface into the nozzle hole 118 (see small diagram associated with reference symbol C2). After that, in synchrony with the timing when the drawn meniscus surface again starts to move toward the outlet of the nozzle, the volume of the pressure generation chamber 115 is slightly reduced (see small diagram associated with reference symbol C3), so as to jet a small dot of the ink material 122. The second discharge (see reference symbol C4) after interruption of the discharge is performed for damping the vibration of the meniscus surface and the residual signal applied to the piezoelectric element 120 and for controlling the jetting form of the ink material 122.

The waveform WD, formed during the section “Part 3” of the basic waveform, is used for jetting a medium dot. From the initial static state (see small diagram D1), the meniscus surface is gradually and greatly drawn toward the interior of the nozzle (see small diagram associated with reference symbol D2). After that, in synchrony with the timing when the meniscus surface again starts to move toward the outlet of the nozzle, the volume of the pressure generation chamber 115 is suddenly reduced (see small diagram associated with reference symbol D3), so as to jet a medium dot of the ink material 122. After that, suitable charge and discharge operations for the piezoelectric element 120 is performed (see reference symbol D4), so as to damp the residual vibration of the meniscus surface and the piezoelectric element 120.

The waveform WE, formed during the sections “Part 2” and “Part 3” of the basic waveform, is used for jetting a large dot of the ink material 122. In the steps indicated by reference symbols E1 to E3, a minute dot of the ink material 122 is jetted. After that, in synchrony with the timing when the nozzle hole 118 is again filled with the ink material 122 by minute residual vibration of the meniscus surface, a waveform for jetting a medium dot is applied to the piezoelectric element 120. The ink material 122 jetted during the steps indicated by reference symbols E4 and E5 is a dot whose volume is larger than the medium dot, so that an even larger dot of the ink material 122, which includes this larger dot and the previous small dot, is formed. According to the above control of the driving signal, the ink material 122 can be jetted in any of three different sizes (i.e., volumes) of small, medium, and large dots.

The droplet jetting apparatus 101 of the present embodiment employs a droplet jetting method, by which the above-explained jetting control can be independently performed for each of the nozzle holes 118. Therefore, the target area for jetting can be easily determined. That is, it is possible to effectively jet liquid material toward a limited concave portion on a target coating film.

Ink Material

The type of the ink material 122 used in the droplet jetting apparatus 101 is determined depending on the characteristics of the wiring layer, the inter-layer conductive post, and the inter-layer insulating film, which are constituents of the multilayer circuit board. As the ink material for forming the wiring layer of the present embodiment, conductive ink which is electrically conductive is used. This conductive ink is obtained by using a solution (product name: Perfect Silver, manufactured by Vacuum Metallurgical Co., Ltd) in which silver particles having a diameter of approximately 10 nm are dispersed in toluene, and this solution is diluted with toluene and the viscosity of the diluted solution is adjusted to 3 mPa·s so as to obtain the conductive ink.

Ink-Repellent Coating Process

Below, the ink-repellent coating process subjected to the upper surface of the substrate will be explained. According to this process, the position of the conductive ink or the like, jetted onto the substrate, can be further accurately controlled.

After the substrate 10 made of polyimide is cleaned using IPA (isopropyl alcohol), the substrate 10 is irradiated with ultraviolet (UV) light having a wavelength of 254 nm at an intensity of 10 mW/cm² for 10 minutes, so as to perform an additional cleaning step (i.e., UV irradiation cleaning). In order to subject this substrate 10 to the ink-repellent coating process, 0.1 g of hexadecafluoro-1,1,2,2-tetrahydrodecyltriethoxysilane and the substrate 10 are put into a closed vessel and are kept in the vessel at 120° C. for 2 hours. Accordingly, an ink-repellent monomolecular film is formed on the substrate 10. The contact angle between the upper surface of the substrate 10, on which the ink-repellent monomolecular film is formed, and the conductive ink jetted toward this upper surface is, for example, approximately 70 degrees.

The above contact angle between the surface of the substrate after the ink-repellent coating process and the conductive ink is too large to form multilayer printed wiring by the droplet jetting method. Therefore, this substrate 10 is further irradiated with UV light having the same wavelength (i.e., 254 nm) as that used in the above cleaning step for two minutes, thereby obtaining a contact angle of approximately 35 degrees between the conductive ink and the surface of the substrate.

Instead of performing the ink-repellent coating process, a receptive layer may be formed.

First Circuit Pattern Forming Process

The droplet jetting apparatus 101 is used for jetting conductive ink 122a (see FIG. 1A) from the inkjet head 102a toward the substrate 10 which has been subjected to the above-explained ink-repellent coating process, so that a bit map pattern having specific dot intervals is formed. After that, a heating step is performed so as to produce a circuit pattern.

As the inkjet head 102, a commercially-available head (e.g., that used in a commercially-available printer “Colorio”, manufactured by Seiko Epson Corporation) may be used. However, the ink drawing unit used for such a commercially-available head is made of plastics; thus, a metallic unit is used instead of the plastic unit so as not to be dissolved by organic solvent. When the conductive ink is jetted at a driving voltage of the inkjet head 102a of 20V, 5 picoliter of conductive ink 122a is jetted. In this case, the jetted conductive ink 122a has a diameter of approximately 27 μm. After the conductive ink 122a is jetted toward the substrate 10 (at a contact angle of 35 degrees), the conductive ink 122a forms a spot having a diameter of approximately 45 μm on the substrate 10.

As a specific example of the circuit pattern drawn on the substrate 10, a binary (i.e., black and white) bit map, produced on a grid consisting of squares whose each side has a length of 50 μm, was designed. The conductive ink 122a was jetted according to this bit map. That is, the conductive ink including silver particles is jetted from the inkjet head 102a toward the substrate 10, where the unit interval between the jet positions is 50 μm (see FIG. 1A).

Under the above conditions, each droplet 13 jetted onto the substrate 10 has a diameter of approximately 45 μm; thus, the adjacent droplets 13 do not contact each other, and each dot (i.e., droplet 13) is separate on the substrate 10. After the jetting corresponding to a target pattern, the substrate 10 is subjected to hot air drying at 100° C. for 15 seconds, so as to drive off the solvent in the conductive ink. After that, the substrate 10 is allowed to cool naturally for a few minutes until the temperature of the substrate 10 returns to room air temperature, so that the state as shown in FIG. 1B is produced.

After the above step, the ink-repellent characteristics of the substrate 10 is maintained. In addition, the solvent component is removed from each droplet 13 while drying and the like, thereby forming ink droplet 14 whose thickness is approximately 2 μm. The surface of this ink droplet 14 has ink-repellent characteristics almost the same as those of the portions where no ink droplet 14 is formed.

After that, as shown in FIG. 1C, droplets 15 of the same liquid as that of the droplet 13 are jetted in a manner such that each droplet 15 is jetted onto the middle between two independent and adjacent dots (i.e., ink droplets 14). FIG. 1C shows only a sectional view; however, when independent dots similar to the ink droplets 14 are also present in a direction perpendicular to the plane of this figure, droplets 15 are also jetted onto the medium positions between these dots.

In this step of droplet jetting, the ink-repellent characteristics of the substrate 10 and the ink droplet 14 are almost the same; thus, it is possible to obtain almost the same results as those obtained by jetting toward a substrate 10 on which no ink droplet 14 is formed.

After that, the substrate 10 having the droplets 15 is subjected to hot air drying (similar to the above-explained hot air drying), so as to evaporate the solvent component of the conductive ink. Accordingly, as shown in FIG. 1D, a pattern 16 is formed, in which all ink droplets produced at adjacent grid points are joined.

In order to increase the thickness of the film and to prevent the dot shapes from remaining in the circuit pattern for the wiring layer, the jetting step toward the target middle (or concave) position between the dots and the hot air drying step are repeated six times (including the above-explained first execution), thereby forming the first circuit pattern 17 having a line width of 50 μm and a film thickness of 10 μm (refer to FIG. 1E). At this stage, only the solvent component of the conductive ink has been removed and the substrate has been insufficiently baked. Therefore, the circuit pattern is no electrically conductive.

Inter-Layer Conductive Post Forming Process

In the next process, the inter-layer conductive posts 18, which pass through an inter-layer insulating film, are formed for providing electrical conductivity between the first and second circuit patterns. Here, the inter-layer conductive posts 18 can be formed via the same process as that of the above-explained first circuit pattern forming process. That is, the conductive ink 122a including silver particles is jetted toward only areas where inter-layer conduction is required, and this jetting step is repeated while hot air drying is performed after each jetting step. The jetting step, repeated six times, produces the inter-layer conductive posts 18 having a height of 10 μm measured from the first circuit pattern (see FIG. 1F).

After that, the substrate 10 is subjected to thermal treatment at 300° C. for 30 minutes in the air, so as to make the silver particles physically contact each other. Accordingly, the first circuit pattern 17 and each inter-layer conductive post 18 are physically joined with each other. In addition, according to the above thermal treatment, the total film thickness of the first circuit pattern 17 and the inter-layer conductive post 18 is almost half as much as that before the thermal treatment (see FIG. 1G). According to a Sellotape (registered trademark) test for evaluating the adhesion strength between the first circuit pattern 17 and the substrate 10, sufficient adhesion strength by which no separation occurs is evaluated.

Insulating Film Formation Area Computing Process

In the next process, an insulating film formation area is computed. The insulating film formation area 19a is an area where an inter-layer insulating film is formed in a subsequent process, and the area 19a (see FIG. 1H) is computed based on design data which include (i) electronic data such as the bit map pattern of the first circuit pattern 17 and the inter-layer conductive posts 18 and (ii) set values such as the jetted amount of each droplet, the arrangement of droplets, the number of times the jetting step is performed, and the like.

According to the calculations based on the design data, the insulating film formation area 19a is computed, which is determined by (i) a concavo-convex shape formed by the upper surface 10 of the substrate 10, the upper surface 17a and side faces 17b of the first circuit pattern 17, and the side faces 18b of the inter-layer conductive posts 18, and (ii) a desired film thickness of the inter-layer insulating film.

The insulating film formation area computing process is executed by the CPU such as a microprocessor for controlling the entire system of the droplet jetting apparatus 101, or a computer having input/output functions for various signals. Therefore, the computing process may be performed at any time before the inter-layer insulating film is formed.

Ink Affinity Providing Process

In a pretreatment process for the formation of the inter-layer insulating film in the insulating film formation area 19a, the substrate 10, on which the first circuit pattern 17 is formed, is irradiated with UV light having a wavelength of 254 nm at an intensity of 10 mW/cm² for five minutes, thereby providing ink affinity (characteristics) to the upper surface 10a of the substrate 10, the upper surface 17a and the side faces 17b of the first circuit pattern 17, and the side faces 18b of the inter-layer conductive posts 18.

First Inter-Layer Insulating Film Forming Process

In the next process, an inter-layer insulating film is formed so as to cover the insulating film formation area 19a with an insulating film.

The ink material for forming the inter-layer insulating film of the present embodiment is obtained by, for example, diluting commercially-available polyimide varnish (product name: Pimel, manufactured by Asahi Kasei Corporation) with a solvent and by controlling the viscosity of the diluted material to be 8 mPa·s.

The droplet jetting apparatus 101 is then operated for jetting the above-explained ink material 122b in a manner such that only concave portions formed by the upper surface 10a of the substrate 10 and the first circuit pattern 17 are filled with the ink material (see FIG. 2A).

In the step of jetting the ink material 122b, the driving waveform of the voltage applied to the inkjet head 102b is controlled, so as to adjust the amount of the ink material 122b jetted per unit area. For example, when the driving waveform is defined so as to apply a relatively high voltage to the piezoelectric element 120, the amount jetted per droplet can be increased. Conversely, when the driving waveform is defined so as to apply a relatively low voltage to the piezoelectric element 120, the amount jetted per droplet can be decreased. On the other hand, when the driving waveform is defined so as to increase the number of pulses per unit time of the voltage applied to the piezoelectric element 120, the amount jetted per unit area can be increased, and conversely, when the driving waveform is defined so as to decrease this number of pulses per unit time, the amount jetted per unit area can be decreased.

The ink material 122b is jetted at desired jet intervals by suitably setting the relative movement speed between the substrate 10 and the inkjet head 102b by using the controller CONT. Here, the time interval for jetting during the relative movement may be changed. For example, when the relative movement speed is set to be higher, larger distance intervals (between jet positions) are obtained, so that the jet points of the ink material 122b can be sparsely arranged. Conversely, when the relative movement speed is set to be lower, smaller distance intervals are obtained, so that the jet points of the ink material 122b can be closely arranged. If droplet jetting is performed at the same point without performing the relative movement, so-called double coating can be performed. Additionally, the amount jetted per unit area can be changed by controlling the jetting/non-jetting state of each nozzle.

As explained above, in the first step for forming the inter-layer insulating film, the ink material 122b is jetted toward the concave portions formed by the upper surface 10a of the substrate 10 and the side faces 17b of the first circuit pattern 17 in the insulating film formation area 19b (see FIG. 2A). The upper surface 10a and the side faces 17b have ink affinity; thus, the jetted ink material 122b is spread over the above concave portions and all the concave portions are filled with the ink material 122b, as shown in FIG. 2B. Here, the upper surface of the ink material 122b is flat due to the self-leveling effect.

The substrate 10 is then subjected to thermal treatment at 400° C. for 30 minutes so as to remove the solvent component included in the ink material 122b, thereby forming the first inter-layer insulating film 22. As a result, as shown in FIG. 2C, the film thickness of the first inter-layer insulating film 22 is almost the half as much as that of the ink material 122b before the thermal treatment. Therefore, the ink material 122b is again jetted onto the first inter-layer insulating film 22, similarly to the above jetting step, and similar thermal treatment (i.e., at 400° C. for 30 minutes) is performed so as to cure the ink material, so that the concave portions formed by the upper surface 10a of the substrate 10 and the side faces 17b of the first circuit pattern 17 are filled with the first inter-layer insulating film 22, and a flat surface is formed at the level (i.e., height) of the upper surface 17a of the first circuit pattern 17, as shown in FIG. 2D. The above steps of jetting the ink material 122b and the thermal treatment may be repeated any number of times as is appropriate.

Second Inter-Layer Insulating Film Forming Process

In the next process, the ink material 122b is jetted in a manner such that concave portions formed by the flat upper surface 17a of the first circuit pattern 17, the upper surface 22a of the first inter-layer insulating film 22, and the side faces 18b of the inter-layer conductive posts 18 are filled with the ink material 122b, thereby forming the second inter-layer insulating film 23.

The upper surface 17a and the side faces 18b have ink affinity, and the upper surface 22a have the same composition as polyimide varnish included in the ink material 122b. Therefore, the jetted ink material 122b is spread over the above concave portions, and all the concave portions are filled with the ink material 122b, as shown in FIG. 2F. Here, the upper surface of the ink material 122b is flat due to the self-leveling effect.

The substrate 10 is then subjected to thermal treatment at 400° C. for 30 minutes, so as to remove the solvent component included in the ink material 122b, thereby forming the second inter-layer insulating film 23. As a result, as shown in FIG. 2G, the film thickness of the second inter-layer insulating film 23 is almost the half as much as that of the ink material 122b before the thermal treatment. Therefore, the ink material 122b is again jetted onto the second inter-layer insulating film 23, similarly to the above jetting step, and similar thermal treatment (i.e., at 400° C. for 30 minutes) is performed so as to cure the ink material, so that the concave portions formed by the upper surface 17a of the first circuit pattern 17 and the side faces 18b of the inter-layer conductive posts 17 are filled with the second inter-layer insulating film 23, and the upper surface 23a of the second inter-layer insulating film 23 is flat, as shown in FIG. 2H.

As explained above, the first inter-layer insulating film 22 and the second inter-layer insulating film 23 are formed in a manner such that these films are stacked, thereby forming the inter-layer insulating film 24 having a flat upper surface.

The above steps of jetting the ink material 122b and the thermal treatment may be repeated any number of times as is appropriate.

Preferably, the upper surfaces 18a of the inter-layer conductive posts 18 are slightly higher than the upper surface 23a of the second inter-layer insulating film 23 (by approximately 0.1 μm).

Second Circuit Pattern Forming Process

In order to form the second circuit pattern 31 (i.e., the second wiring layer) on the inter-layer insulating film 24, the same process as that for forming the first circuit pattern is performed. That is, IPA cleaning, UV irradiation cleaning, ink-repellent coating process using alkylsilane fluoride, control of the contact angle by performing UV irradiation, pattern formation by jetting ink including silver particles, and hot air drying are performed. Here, the process of “ink jetting→hot air drying” is repeated as many times as necessary. Accordingly, a multilayer circuit board can be produced.

In order to produce a multilayered board including further multilayered structure, as shown in FIG. 3A, an inter-layer conductive post 32 is formed similarly to the first circuit pattern 17, and the inter-layer conductive post 32 is also baked together with the second circuit pattern, so as to provide electrical conductivity. The inter-layer insulating film 33, as shown in FIG. 3B, is further formed in the same process as that for forming the inter-layer insulating film 24. Such a series of processes is repeated as many times as necessary, thereby producing a multilayer circuit board having a desired multilayer level. FIG. 3C shows an example in which the third wiring layer (i.e., the third circuit pattern) is formed above the first and second wiring layers.

As explained above, a flat upper surface of the inter-layer insulating film 24 can be formed based on the design data for the first circuit pattern 17 and the inter-layer conductive posts 18.

According to the flat upper surface of the inter-layer insulating film 24, the film thickness of the second circuit pattern 31 can be made uniform, so that preferable insulation performance can be provided between the first circuit pattern 17 and the second circuit pattern 31, and disconnection between the wiring layers can be avoided.

In addition, the second circuit pattern 31 is formed on the upper surface of the inter-layer insulating film 24; thus, the second circuit pattern 31 is formed along the flat surface of the inter-layer insulating film 24. Therefore, if films for further upper layers (i.e., third or more circuit pattern layers or inter-layer insulating films) are formed, the upper surface of each film can also be easily leveled and the thickness of the film can also be easily made uniform.

The shape of the insulating film formation area 19a is computed in advance based on the design data for the first circuit pattern 17 and the inter-layer conductive posts 18; thus, no process for measuring the insulating film formation area 19a is necessary.

Additionally, a suitable amount of ink material 122 can be jetted by controlling the driving waveform of the voltage applied to the inkjet head 102; thus, the amount of the jetted ink per unit area of the insulating film formation area 19a can also be controlled. The distance intervals between the jet points can also be controlled; thus, it is possible to control how closely or far apart the ink material 122 is deposited, and also to control the amount of the jetted ink per unit area of the insulating film formation area 19a.

Second Embodiment

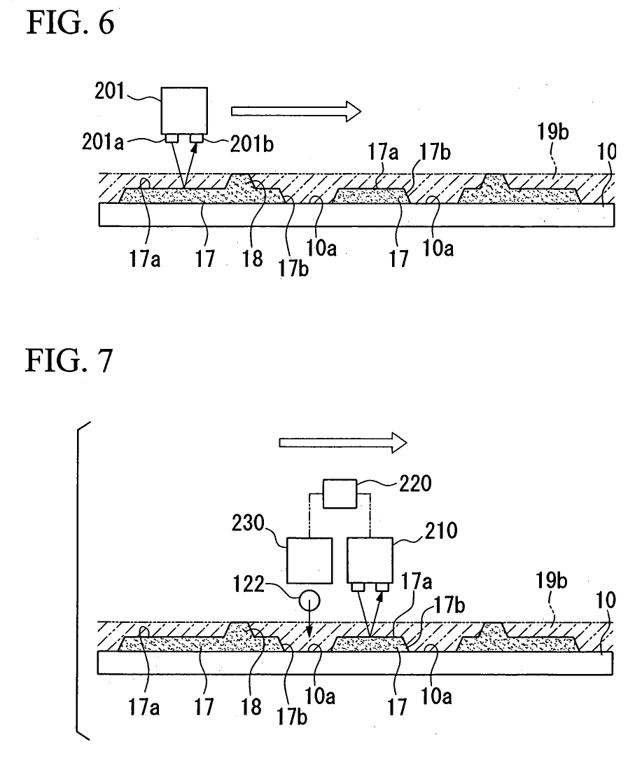

FIG. 6 is a diagram showing a process in the manufacturing method of the multilayer circuit board in the second embodiment of the present invention. In the present embodiment, instead of the insulating film formation area computing process in the first embodiment, an insulating film formation area measuring process is performed. The other processes are similar to those in the first embodiment.

Below, a process different from the first embodiment will be explained in detail. Regarding the other processes, only a flow of the series of the processes for forming the multilayer circuit board will be explained. In FIG. 6, parts identical to those in FIG. 1A to FIG. 4B are given identical reference numerals.

In the manufacturing method of the multilayer circuit board of the present embodiment, after (i) the ink-repellent process for the substrate 10, (ii) the first circuit pattern forming process, and (iii) the inter-layer conductive post forming process are performed in turn (see FIGS. 1A to 1G), the insulating film formation area measuring process as shown in FIG. 6 is performed.

Insulating Film Formation Area Measuring Process (1)

This process is performed using a laser step measurement device which is a kind of contactless step measurement device. The laser step measurement device has a head which includes a light emitting section and a light receiving section, and the vicinity of a target object to be measured is scanned by this head, so that the distance between the head and the target object is measured by using optical interference.

As shown in FIG. 6, the entire surface of the substrate 10 on which the first circuit pattern 17 and the inter-layer conductive posts 18 are formed is scanned by the head 201, so as to irradiate the substrate 10 with a laser beam from the light emitting section 201a and to detect a reflected beam by the light receiving section 201b. Accordingly, concavo-convex portions are accurately measured as three-dimensional data.

Based on the three-dimensional data, image analysis or the like is performed so as to compute the insulating film formation area 19b, thereby determining an optimum jetted amount, droplet arrangement, number of times the jetting operation is performed, etc., of the ink material 122, which is jetted toward the insulating film formation area 19b.

In the next step after the insulating film formation area measuring process, the substrate 10 is subjected to the ink affinity providing process and is further subjected to the first inter-layer insulating film forming process and the second inter-layer insulating film forming process which are performed based on the insulating film formation area 19b, thereby forming an inter-layer insulating film having a flat upper surface. The second circuit pattern forming process is then performed, thereby producing a multilayer circuit board (refer to FIGS. 2A to 3C).

As explained above, the inter-layer insulating film can be formed in the insulating film formation area 19b, based on the three-dimensional data (i.e., measurement data) for the insulating film formation area 19b, which are obtained by the laser step measurement device.

Here, the actual shape including a dimensional error in the concavo-convex portions (i.e., an error between the design data and the measurement data), which is produced when the first circuit pattern and the inter-layer conductive posts are formed, is measured. Therefore, in comparison with the inter-layer insulating film formed based on the design data, the inter-layer insulating film can be made more accurately level in the present embodiment.

The contactless step measurement device is not limited to the laser step measurement device, and a scanner may be used.

FIG. 7 shows a variation of the manufacturing method of the multilayer circuit board of the present embodiment. In this variation, instead of the laser step measurement device, a head-preceding sensor (which precedes the inkjet head) is employed for performing the insulating film formation area measuring process. The head-preceding sensor is positioned in the vicinity of the droplet jetting head and measures steps in the concavo-convex portions. Below, explanations for the processes other than the insulating film formation area forming process of this variation will be omitted.

Insulating Film Formation Area Measuring Process (2)

In the present variation, the insulating film formation area measuring process is performed using a head-preceding sensor positioned close to the droplet jetting head.

As shown in FIG. 7, the head-preceding sensor 210 is connected to the inkjet head 230 via the controller 220. The substrate 10 is scanned by the head-preceding sensor 210, and steps in the concavo-convex portions of the first circuit pattern 17 and the inter-layer conductive posts 18 are measured before the jetting of droplets.

That is, the head-preceding sensor 210, which precedes the inkjet head 230, scans the substrate 10 on which the first circuit pattern 17 and the inter-layer conductive posts 18 are formed, so as to measure the steps in the concavo-convex portions. Based on the measurement results of the head-preceding sensor 210, the controller 220 drives the inkjet head 230, so that droplet jetting is performed. Here, the step measurement for the concavo-convex portions and the droplet jetting are performed in parallel.

As explained above, the measurement of the insulating film formation area 19b and the droplet jetting are performed in parallel, and the inter-layer insulating film can be formed in the insulating film formation area 19b. In addition, in this variation, measurement of the entire surface for the insulating film formation area by using a laser step measurement device is unnecessary, and it is possible to efficiently perform the step measurement in concave portions and the droplet jetting operation.

Furthermore, the actual shape including a dimensional error in the concavo-convex portions (i.e., an error between the design data and the measurement data), which is produced when the first circuit pattern and the inter-layer conductive posts are formed, is measured. Therefore, in comparison with the inter-layer insulating film formed based on the design data, the inter-layer insulating film can be made more accurately level in the present embodiment.

Third Embodiment

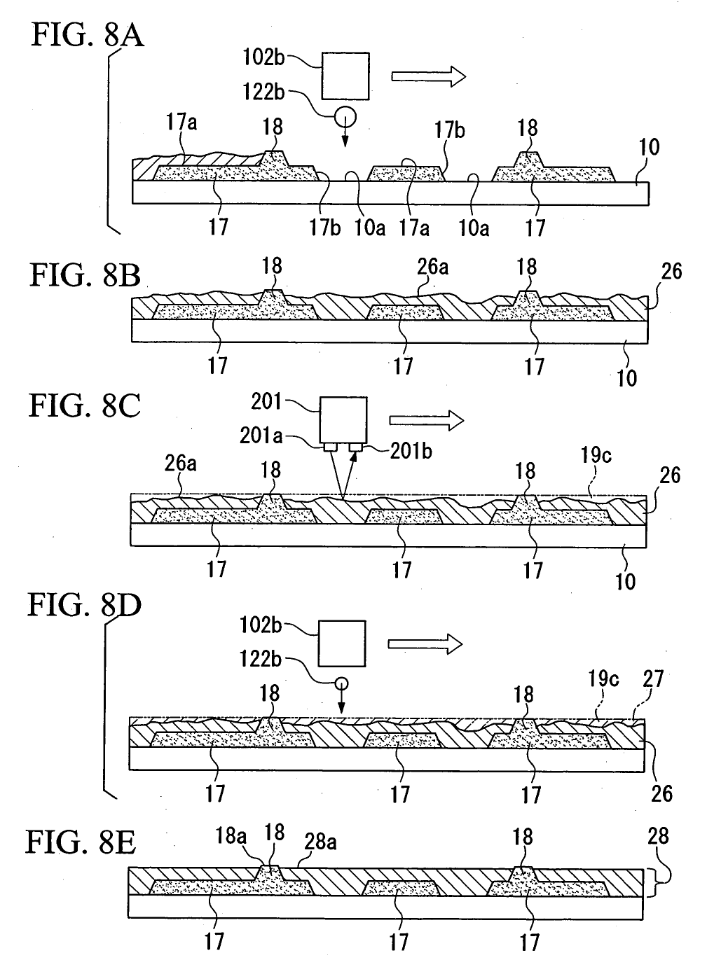

FIGS. 8A to 8E are diagrams showing processes of the manufacturing method of the multilayer circuit board in the third embodiment of the present invention. In this embodiment in which a plurality of inter-layer insulating films are formed, after the first inter-layer insulating film is produced, steps in the upper surface of the first inter-layer insulating film are measured, and based on the measurement data, the second inter-layer insulating film is formed so as to make the upper surface of the first inter-layer insulating film level.

Below, only processes different from those of the first and second embodiments will be explained in detail. Regarding the other processes, only a flow of the series of the processes for forming the multilayer circuit board will be explained. In FIGS. 8A to 8E, parts identical to those in FIG. 1 to FIG. 7 are given identical reference numerals.

In the manufacturing method of the multilayer circuit board of the present embodiment, after (i) the ink-repellent process for the substrate 10, (ii) the first circuit pattern forming process, and (iii) the inter-layer conductive post forming process are performed, the insulating film formation area computing process and the ink affinity providing process are successively performed (see FIGS. 1A to 1H), and the first inter-layer insulating film forming process as shown in FIG. 8A is performed.

In this first inter-layer insulating film forming process, the first inter-layer insulating film 26 is formed by relatively large droplets so as to reduce the time necessary for the droplet jetting process, and also with relatively large distance intervals between the jet points.

In this formation of the first inter-layer insulating film 26, the driving waveform of the voltage applied to the inkjet head 102b of the droplet jetting apparatus 101 is controlled so as to adjust the amount of the ink material 122b jetted per unit area. In addition, the relative movement speed between the substrate 10 and the inkjet head 102b can be changed via the controller CONT, so that the droplet jetting can be performed at desired distance intervals between the jet points. This substrate 10 is then thermally-treated so that the solvent component included in the ink material 122b is removed, and the first inter-layer insulating film 26 is cured.

Accordingly, the first inter-layer insulating film 26 as shown in FIG. 8B is formed. In the above process, the ink material 122b is jetted as relatively large droplets which are sparsely arranged; thus, the upper surface 26a of the first inter-layer insulating film 26 is not accurately flat.

Next, the insulating film formation area measuring process is performed (see FIG. 8C), in which steps on the upper surface 26a of the first inter-layer insulating film 26 are measured.

This insulating film formation area measuring process is performed using a laser step measurement device, which is a contactless step measurement device. More specifically, the entire surface of the substrate 10, on which the first inter-layer insulating film 26 is formed, is scanned by the head 201 so as to irradiate the upper surface 26a of the first inter-layer insulating film 26 with a laser beam from the light emitting section 201a and to detect a reflected beam by the light receiving section 201b. Accordingly, steps on the upper surface 26a are accurately measured as three-dimensional data.

Based on the three-dimensional data, image analysis or the like is performed so as to compute the insulating film formation area 19c, thereby determining an optimum jetted amount, droplet arrangement, number of times the jetting operation is performed, etc., of the ink material 122b, which is jetted toward the insulating film formation area 19c.

Next, the second inter-layer insulating film forming process is performed, as shown in FIG. 8D.

According to the insulating film formation area 19c, the ink material 122b is jetted as droplets which are smaller than the above-explained relatively large droplets and which are closely jetted, so as to fill the concave portions in the steps of the first inter-layer insulating film. In the droplet jetting, the driving waveform of the voltage applied to the inkjet head 102b of the droplet jetting apparatus 101 is controlled so as to adjust the amount of the ink material 122b jetted per unit area. In addition, the relative movement speed between the substrate 10 and the inkjet head 102b can be changed via the controller CONT, so that the droplet jetting can be performed at desired distance intervals between the jet points. This substrate 10 is then thermally-treated so that the solvent component included in the ink material 122b is driven off, and the second inter-layer insulating film 27 is cured, thereby producing the inter-layer insulating film 28 (see FIG. 8E) which has been formed by stacking layers and whose upper surface 28a is flat.

The substrate 10, which has been subjected to the second inter-layer insulating film forming process, is then subjected to the second circuit pattern forming process (see FIG. 3A), thereby producing a multilayer circuit board.

As explained above, the steps on the upper surface 26a of the first inter-layer insulating film 26 are measured; thus, actual steps in consideration of errors in the film thickness and the flatness of the first inter-layer insulating film 26 can be measured.

The second inter-layer insulating film 27 is formed so as to fill the concave portions in the steps, so that the upper surface 28a of the inter-layer insulating film 28 can be flat. Therefore, the upper surface 26a of the first inter-layer insulating film 26 can be relatively roughly formed in comparison with the second inter-layer insulating film 27; thus, it is possible to form the first inter-layer insulating film 26 by which the time necessary for the droplet jetting method can be reduced.

In addition, the first inter-layer insulating films 26 and the second inter-layer insulating film 27 are separately formed in turn; thus, the amount of jetted droplets for forming the second inter-layer insulating film 27 is less than that for forming a desired inter-layer insulating film 28 at one time. Therefore, it is possible to perform droplet jetting whose important factor is control of the amount of jetting, thereby forming the upper surface 28a which is accurately flat.

In the present embodiment, the first inter-layer insulating film 26 is formed by the droplet jetting method; however, this is not a limiting condition. That is, the first inter-layer insulating film 26 may be formed by another method, for example, spin coating or the like, and steps on this layer film are measured, and then the second inter-layer insulating film 27 is formed so as to fill concave portions in the steps.

Fourth Embodiment

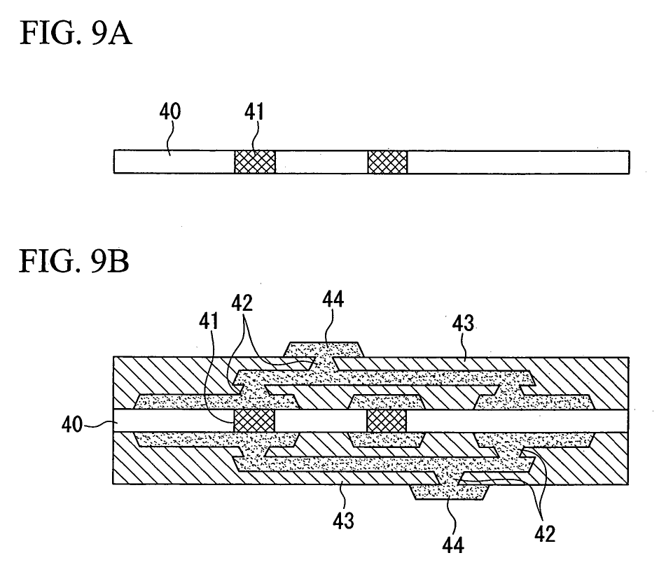

FIGS. 9A and 9B are diagrams showing processes performed in the manufacturing method of the multilayer circuit board in the fourth embodiment of the present invention. In this embodiment, multilayer printed wiring is formed at both sides (i.e., on both faces) of the core substrate 40.

When the circuit pattern and the insulating film pattern are formed by the droplet jetting method similar to those in the first to the third embodiments, only a one-sided substrate can be obtained. In order to form multilayer printed wiring at both sides of the substrate, an ordinary both-side wiring substrate is used as the core substrate 40, and each side of the substrate is subjected to the processes similar to those performed in the first to the third embodiments.

Preferably, the core substrate 40 has no through holes; thus, through holes are preferably filled with metal paste 41 (which can be a wiring layer). If a substrate having a thin copper film at one side is used, non-through holes may be provided and these holes are filled with metal paste. Such holes can be provided by known photolithography or laser irradiation. In addition, the above-explained through holes or non-through holes may be filled with conductive ink which includes silver particles (i.e., similar to the conductive ink used in the first to third embodiments) by the droplet jetting method.

Accordingly, first, circuit patterns are formed at both sides of the core substrate 40, and a series of (i) the process of forming the inter-layer conductive posts 42, (ii) the process of forming the inter-layer insulating film 43, and (iii) the process of forming the next-layer circuit pattern 44 (i.e., next wiring layer) are performed in turn and repeated according to need for each side, thereby producing multilayer printed wiring at both sides of the core substrate 40.

Fifth Embodiment

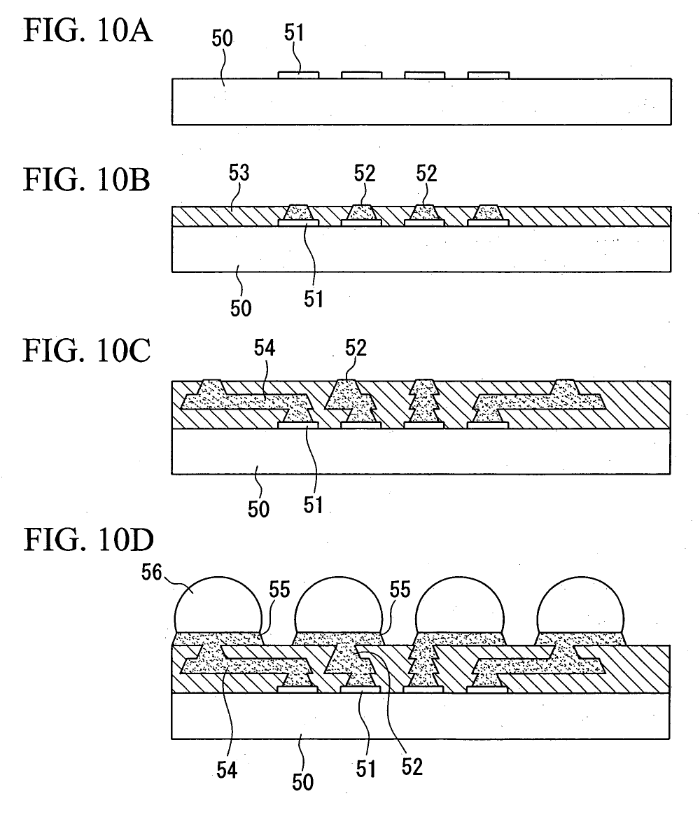

FIGS. 10A to 10D are diagrams showing the processes of the manufacturing method of the multilayer circuit board in the fifth embodiment of the present invention. This embodiment employs the CSP (chip scale package) method so as to form additional wiring, that is, to form multilayer printed wiring by directly forming a circuit pattern on a chip.

As shown in FIG. 10A, first, the IC chip 50, on which electrode pads 51 have already been formed, is subjected to the ink-repellent process using a monomolecular film. This process is almost the same as that explained in the first to the third embodiments, except that decyl-triethoxysilane is used as the material for the monomolecular film.

Next, as shown in FIG. 10B, inter-layer conductive posts 52 are formed according to the process as explained in the first to the third embodiments, where each inter-layer conductive post 52 is positioned on the center of each electrode pad 51 and has a height of 5 μm and a diameter of 50 μm. In addition, the inter-layer insulating film 53 is formed in a manner such that the height of the film 53 is almost the same as that of the upper surface of the inter-layer conductive posts 52. Accordingly, the inter-layer insulating film 53 having a flat upper surface can be formed while the upper surface of each inter-layer conductive post 52 is reliably exposed.

After that, similarly to the above-explained processes, the ink-repellent process, the second circuit pattern forming process, the inter-layer conductive post forming process, and the inter-layer insulating film forming process are performed in turn, thereby producing additional wiring 54 (i.e., additional wiring layer) connected to the electrode pads 51 on the IC chip 50. Next, pads 55 (which also function as the wiring layer) and bumps 56 (which also function as the wiring layer) formed on the pads 55 are formed on the inter-layer conductive posts 52 which are exposed in the surface of the substrate, by a method similar to known photolithography or that similar to the wiring formation performed in the first embodiment.

Sixth Embodiment

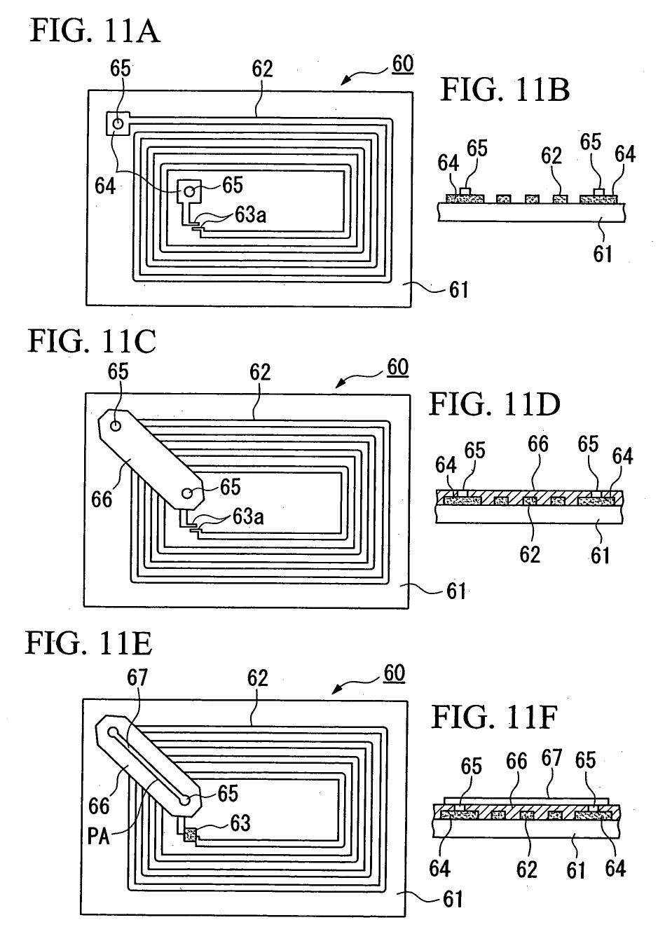

FIGS. 11A to 11F are diagrams showing the processes of the manufacturing method of the multilayer circuit board in the sixth embodiment of the present invention. In this embodiment, the coil portion as the termination of an antenna in the wireless IC card 60 (which is a multilayer circuit board) is formed by a manufacturing method as explained above. FIGS. 11B, 11D, and 11F are respectively sectional views of FIGS. 11A, 11C, and 11E, each sectional view provided along a line between two pads 65 and 65.

This wireless IC card 60 has an IC chip 63 mounted on a polyimide film 61, and an antenna 62 (which is a wiring layer) having a coil shape. The IC chip 63 includes a nonvolatile memory, logic circuits, high-frequency circuits, and the like, and operates by receiving radio waves transmitted from an external transmitter via the antenna 62 and receiving supplied electrical power. The IC chip 63 also analyzes the signal received via the antenna 62, and transmits a specific required signal corresponding to the analyzed results.

In order to produce such a wireless IC card, first, the coil-shaped antenna 62 is formed on the polyimide film 61 (see FIG. 11A), in a process similar to the first circuit pattern forming process of the first embodiment. In this process, the pads 64 (functioning as the wiring layer) and the terminals 63a between which the IC chip 63 is mounted are simultaneously formed. After the formation of the antenna 62, similarly to the first embodiment, the inter-layer conductive posts 65 are formed on the pads 64. Next, according to a method as explained in the first to the third embodiments, the inter-layer insulating film 66 is formed by coating the pattern with polyimide material in a manner such that the upper surfaces of the inter-layer conductive posts 65 are exposed (see FIG. 11C).

After the formation of the inter-layer insulating film 66, similarly to the first embodiment, the pattern PA as shown in FIG. 11E is coated with conductive ink which includes silver particles by the droplet jetting method, and the coated portion is cured, thereby forming wiring 67 by which both ends of the coil antenna 62 are connected. In the last step, the IC chip 63 is mounted on a position shown in FIG. 11E by using an anisotropic conductive film, and the entire portion is laminated with a protection film (not shown), thereby producing the wireless IC card 60.

This wireless IC card 60 can communicate with, for example, an external reader/writer close to the IC card (e.g., distance from the IC card is approximately 10 cm or less).

If the pads 64 are relatively large (i.e., having a size of a few mm×a few mm), the inter-layer insulating film 66 may be formed without providing the inter-layer conductive posts 65, in a manner such that areas necessary for the inter-layer conduction are remained (i.e., not covered by the inter-layer insulating film), thereby forming multilayer printed wiring. In this case, the edge on each pad 64 of the inter-layer insulating film layer 66 has a tapered shape; thus, wiring 67 having no disconnection can be formed on the inter-layer insulating film 66 by the droplet jetting method.

Seventh Embodiment

In the seventh embodiment, a TFT (thin film transistor) substrate corresponding to a multilayer circuit board, and a liquid crystal display (LCD) device having the TFT substrate will be explained.

The above-explained manufacturing method of the multilayer circuit board is suitably applied to the manufacturing method of the TFT substrate in the present embodiment; thus, explanation thereof will be omitted.

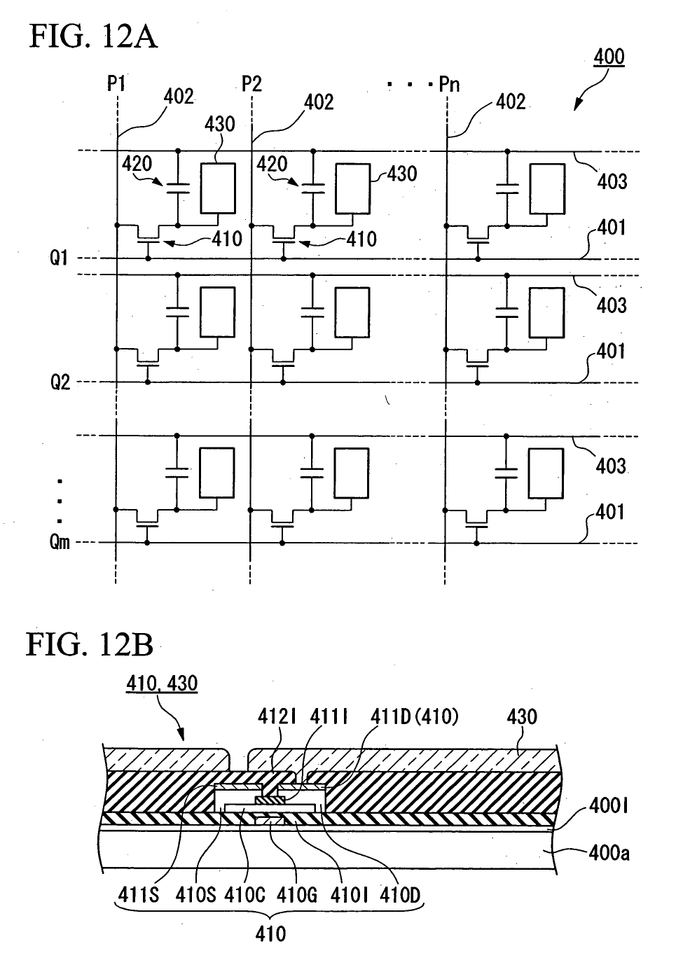

FIGS. 12A and 12B are diagrams for explaining the TFT substrate in the LCD device. FIG. 12A shows an equivalent circuit for indicating elements such as switching TFTs (simply called TFTs, hereinbelow) and wiring lines, which are provided so as to correspond to the image display area of the LCD device. FIG. 12B is a partially-enlarged view showing a main portion of the TFT substrate, and this view is referred to so as to explain the structure of the TFT and the pixel electrode of each pixel.

As shown in FIG. 12A, scan lines 401 and data lines 402, which are arranged in a matrix form, pixel electrodes 430, and TFTs 410 for controlling the pixel electrodes 43 are formed on the TFT substrate 400. In this structure, scan signals Q1, Q2, . . . , and Qm, which are pulse signals, are supplied to the scan lines 401, and image signals P1, P2, . . . , and Pn are supplied to the data lines 402. The scan lines 401 and the data lines 402 are respectively connected to the gate electrodes 410G and the source electrodes 411S of the TFTs 410, as explained below, and the TFTs 410 are driven using the scan signals Q1, Q2, . . . , and Qm, and the image signals P1, P2, . . . , and Pn. In addition, storage capacitors 420 are provided for storing the image signals P1, P2, . . . , and Pn, which have a specific signal level, for a specific period. A capacitance line 403 and a drain electrode 411D (explained below) are respectively connected to both ends of each storage capacitor 420. According to such storage capacitors 420, the electric potential of each pixel electrode 430 can be maintained.

Below, the structure of the TFT 410 will be explained with reference to FIG. 12B. As shown in the figure, the TFT 410 is ofthe so-called bottom gate type (i.e., the inverted-stagger type). Specifically, the insulating substrate 400a as the base of the TFT substrate 400, the ground protection film 4001 formed on the surface of the insulating substrate 400a, the gate electrode 410G, the gate insulating film 410I, the channel area 410C, and the insulating film 411I for channel protection are stacked in turn. At both sides of the insulating film 411I, the source area 410S and the drain area 410D are formed, which are high-density n-type amorphous silicon films. The source electrode 411S and the drain electrode 411D are respectively formed on the surfaces of the source area 410S and the drain area 410D.

The inter-layer insulating film 412I and the pixel electrode 430 are further deposed at the surface sides of the source electrode 411S and the drain electrode 411D, where the pixel electrode 430 is a transparent electrode made of ITO (indium tin oxide) or the like. The pixel electrode 430 is electrically connected to the drain electrode 411D via a contact hole through the inter-layer insulating film 412I.

The above gate insulating film 410I and inter-layer insulating film 412I correspond to the inter-layer insulating film according to the present invention. That is, according to the concavo-convex form of the insulating film formation area (in which the relevant inter-layer insulating film is formed), the film thickness is adjusted so as to produce a flat upper surface of the inter-layer insulating film.

In the TFT substrate having the above-explained structure, current is supplied from the scan lines 401 to the gate electrodes 410G according to the scan signals Q1, Q2, . . . , Qm, so that electric field is generated in the vicinity of the gate electrodes 410G. Owing to this electric field, the channel areas 410C become conductive. In such a conductive state, current is also supplied from the data lines 402 to the source electrodes 411S according to the image signals P1, P2, . . . , Pn, so that the pixel electrodes 430 become conductive, thereby applying voltage between each pixel electrode 430 and the electrode which faces this pixel electrode 430. That is, the LCD device can be suitably driven by controlling the scan signals Q1, Q2, . . . , Qm, and the image signals P1, P2, . . . , Pn.

In the LCD device having the above-explained structure, the gate insulating film 410I and the inter-layer insulating film 412I can be leveled based on the above-explained manufacturing method of the multilayer circuit board. Therefore, the above-explained effects can also be obtained in the present embodiment.

In addition, according to the leveling of the gate insulating film 410I, the surfaces of the TFT 410, the source electrode 411S, and the drain electrode 411D are not uneven but can be flat. Therefore, (i) no problem due to an uneven surface is produced in the coverage area, (ii) no problem such as an undesired residual film after dry etching occurs, and (iii) problems such as generation of leak current, short circuit, and the like, can be prevented, thereby improving the yield of products.

On the other hand, according to the leveling of the inter-layer insulating film 412I, the upper surface of each pixel electrode 430 can be flat; thus, when an alignment film formed on the pixel electrode 430 is subjected to a rubbing process, uniform finish can be obtained, thereby obtaining preferable alignment in liquid crystal material. In addition, the film thickness of the liquid crystal material arranged on the pixel electrodes 430 can be uniform.

The above manufacturing method of the multilayer circuit board is not limited to being applied to the gate insulating film 410I and the inter-layer insulating film 412I, and it can be applied to other insulating films. For example, if inter-layer insulating films are provided between the scan lines 401, the data lines 402, and the capacitance lines 403, the present method can be applied to these insulating films.

In addition, the TFT is of the bottom gate type in the present embodiment; however, the manufacturing method can also be applied to TFTs of the top gate type.

Eighth Embodiment

In the eight embodiment of the present invention, an organic electroluminescent device (abbreviated as “OLED”, hereinbelow) using a TFT substrate as explained in the seventh embodiment will be explained. That is, the TFT substrate employed in OLED is similar to that in the seventh embodiment; thus, explanations thereof will be omitted.

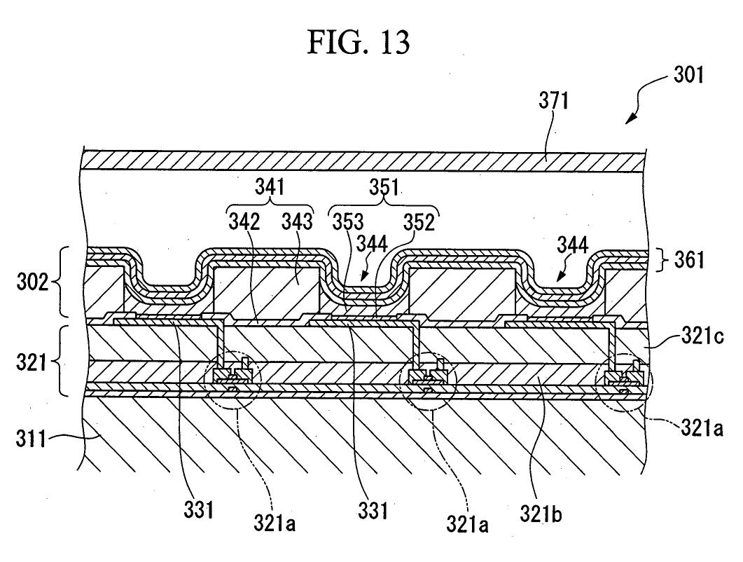

FIG. 13 is a side sectional view showing OLED, a portion of which is produced by the above-explained manufacturing method of the multilayer circuit board. First, the general structure of OLED will be explained.

As shown in FIG. 13, this organic EL device 301 has a substrate 311, a circuit element section 321, pixel electrodes 331, an organic EL element 302, and a sealing substrate 371. The organic EL element 302 includes bank sections 341, light emitting elements 351, and a negative electrode 361 (i.e., counter electrode). Wiring of a flexible substrate (not shown) and a driving IC are suitably connected to the organic EL element 302, the circuit element section 321, and the pixel electrodes 331. The circuit element section 321 is formed on the substrate 311, and the plural pixel electrodes 331 are arranged on the circuit element section 321. Each bank section 341 is provided between adjacent pixel electrodes 331, and the bank sections 341 are arranged in a lattice form. Each light emitting element 351 is provided in each concave portion which is produced due to the bank sections 341. The negative electrode 361 covers the entire upper surface of the bank sections 341 and the light emitting elements 351, and the sealing substrate 371 is provided above the negative electrode 361.

The circuit element section 321 includes the TFTs 321a of the bottom gate type, the first inter-layer insulating film 321b, and the second inter-layer insulating film 321c. The general structure of the TFT 321a is similar to that shown in FIG. 12B, and explanations thereof are omitted here. The first inter-layer insulating film 321b and the second inter-layer insulating film 321c are formed using the manufacturing method according to the present invention. That is, the film thickness of each inter-layer insulating film is adjusted according to the concavo-convex form in the corresponding inter-layer insulating film formation area, so as to level the upper surface of each inter-layer insulating film.

The light emitting elements 351 are formed on the pair of the first inter-layer insulating film 321b and the second inter-layer insulating film 321c, by the droplet jetting method.

OLED 301 as explained above is a so-called (high) polymer EL device having light emitting elements 351 which are produced by the droplet jetting method.

The manufacturing process of OLED 301 having an organic EL element includes a bank section forming step of forming the bank sections 341, a plasma processing step for suitably forming the light emitting elements 351, a light emitting element forming step of forming the light emitting elements 351, a counter electrode forming step of forming the negative electrode 361, and a sealing step of stacking the sealing substrate 371 above the negative electrode 361 for the purpose of sealing.

In the light emitting element forming step, the light emitting elements 351 are produced by forming a hole injection layer 352 and a light emitting layer 353 in each concave portion 344, that is, on each pixel electrode 331; thus, the light emitting element forming step includes a hole injection layer forming step and a light emitting layer forming step. The hole injection layer forming step further includes a first jetting step of jetting the first composition (here, liquid material) for forming the hole injection layer 352 onto each pixel electrode 331, and a first drying step of drying the jetted first composition so as to produce the hole injection layer 352. The light emitting layer forming step further includes a second jetting step of jetting the second composition (here, liquid material) for forming the light emitting layer 353 onto the hole injection layer 352, and a second drying step of drying the jetted second composition so as to produce the light emitting layer 353.

In OLED as produced above, the first inter-layer insulating film 321b and the second inter-layer insulating film 321c are leveled according to the above-explained manufacturing method of the multilayer circuit board, so that the above-explained effects can also be obtained.

In addition, the hole injection layer 352 and the light emitting layer 353 are formed by using the droplet jetting method on the leveled first inter-layer insulating film 321b and second inter-layer insulating film 321c. Therefore, in comparison with a method of forming the hole injection layer 352 and the light emitting layer 353 by jetting liquid materials for the layers 352 and 353 toward the concavo-convex surface, the liquid material does not collect in concave portions, and the liquid material can be equally provided onto the pixel electrodes 331. Therefore, the film thickness of each hole injection layer 352 and the film thickness of each light emitting layer 353 can be uniform. Accordingly, it is possible to completely prevent insufficient emission, reduction in emission life, and short circuits between the pixel electrodes 331 and the corresponding negative electrode 361, which may be caused due to unevenness in the film thickness.

The above organic EL device is not limited to the high polymer type, and it can be of the low-molecular-weight type.

The manufacturing method of the present invention can also be applied to other devices having any wiring pattern, for example, can be used for producing multilayer wiring pattern formed in an electrophoresis device.

Ninth Embodiment

Below, examples of electronic devices having the board or the LCD device, manufactured using the above-explained manufacturing method of the multilayer circuit board, will be explained.

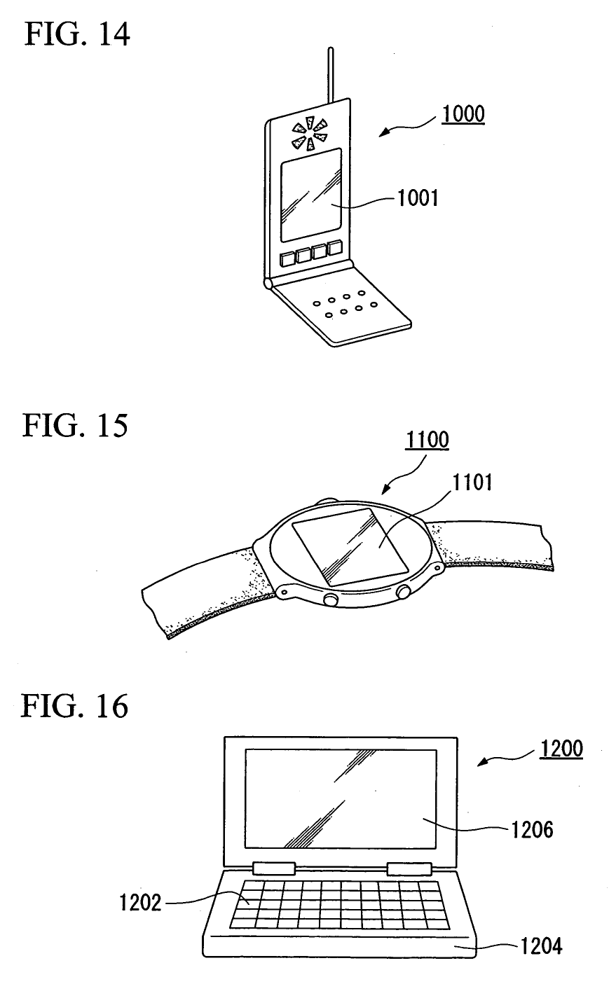

FIG. 14 is a perspective view showing an example of cellular phones (i.e., electronic apparatuses). In FIG. 14, reference numeral 1000 indicates the main body of the cellular phone, which includes a multilayer circuit board produced by the above-explained manufacturing method, and reference numeral 1001 indicates an LCD section 1001 which has an LCD device as explained above.

FIG. 15 is a perspective view showing an example of wristwatch-type electronic apparatuses. In FIG. 15, reference numeral 1100 indicates the main body of the watch, which includes a multilayer circuit board produced by the above-explained manufacturing method, and reference numeral 1101 indicates an LCD section which has an LCD device as explained above.

FIG. 16 is a perspective view showing an example of portable data processing apparatuses (i.e., electronic apparatuses) such as word processors, personal computers, or the like. In FIG. 16, reference numeral 1200 indicates a data processing apparatus, reference numeral 1202 indicates an input section such as a keyboard, reference numeral 1204 indicates the main body of the data processing device, which includes a multilayer circuit board produced by the above-explained manufacturing method, and reference numeral 1206 indicates an LCD section which has an LCD device as explained above.

The electronic apparatuses shown in FIGS. 14 to 16 have multilayer circuit boards and LCD devices, each being produced using the manufacturing method as explained in the above embodiments; thus, the electronic apparatuses can be precisely produced via simpler processes in comparison with conventional apparatuses, and it is possible to reduce the manufacturing period.

The above-explained electronic apparatuses have LCD devices; however, instead of the LCD devices, other electro-optic devices such as organic electroluminescent devices may be included in the electronic apparatuses.

The technical range of the present invention is not limited to the above-explained embodiments, and variations or modifications are possible within the scope and spirit of the present invention. That is, specific materials, layer structure, manufacturing method, and the like, are merely examples and can be suitably modified.

For example, the manufacturing method of the present invention is not limitedly applied to the manufacturing of multilayer printed wiring but can also be applied to multilayer wiring of large display devices or the like.

What is claimed is:

1. A manufacturing method of a multilayer circuit board, comprising the step of forming at least two wiring layers, an inter-layer insulating film provided between every adjacent two of the wiring layers, and conductive posts for providing electrical conductivity between the wiring layers, wherein:
said step includes forming the inter-layer insulating film by changing the film thickness of the inter-layer insulating film according to a concavo-convex shape of an area where the inter-layer insulating film is formed, so as to level an upper surface of the inter-layer insulating film.

2. The manufacturing method as claimed in claim 1, wherein the inter-layer insulating film is formed by using a droplet jetting method.

3. The manufacturing method as claimed in claim 2, wherein the concavo-convex shape of the area where the inter-layer insulating film is formed is computed based on design data of a circuit pattern for forming the wiring layers and the conductive posts.

4. The manufacturing method as claimed in claim 2, wherein the concavo-convex shape of the area where the inter-layer insulating film is formed is measured before the inter-layer insulating film is formed.

5. The manufacturing method as claimed in claim 1, wherein the step of forming the inter-layer insulating film includes forming a plurality of the inter-layer insulating films which are stacked in turn, and this step includes the steps of:
forming the first inter-layer insulating film having a film thickness which is predetermined according to the concavo-convex shape of the area where the inter-layer insulating film is formed, where the concavo-convex shape is computed by design data of a circuit pattern for forming the wiring layers and the conductive posts; and
measuring steps in an upper surface of the first inter-layer insulating film and forming the second inter-layer insulating film in a manner such that concave portions in the steps are filled with the second inter-layer insulating film.

6. The manufacturing method as claimed in claim 5, wherein the inter-layer insulating film is formed by using a droplet jetting method; and
the first inter-layer insulating film is formed by jetting relatively large droplets from a droplet jetting head, and the second inter-layer insulating film is formed by jetting droplets, which are smaller than said relatively large droplets, from the droplet jetting head.

7. The manufacturing method as claimed in claim 1, which uses a droplet jetting method in which the amount of ink material jetted per unit area is controlled by adjusting the amount jetted per droplet of the ink material, where the amount jetted per droplet is changed by controlling a driving waveform for a droplet jetting head.

8. The manufacturing method as claimed in claim 1, which uses a droplet jetting method in which the amount of ink material jetted per unit area is controlled by adjusting distance intervals between positions where the ink material is jetted.

9. A multilayer circuit board comprising:
at least two wiring layers,
an inter-layer insulating film provided between every adjacent two of the wiring layers, which is formed by changing the film thickness of the inter-layer insulating film according to a concavo-convex shape of an area where the inter-layer insulating film is formed, so as to level an upper surface of the inter-layer insulating film; and
conductive posts for providing electrical conductivity between the wiring layers.

10. An electronic device comprising:
at least two wiring layers,
an inter-layer insulating film provided between every adjacent two of the wiring layers, which is formed by changing the film thickness of the inter-layer insulating film according to a concavo-convex shape of an area where the inter-layer insulating film is formed, so as to level an upper surface of the inter-layer insulating film; and
conductive posts for providing electrical conductivity between the wiring layers.

11. The electronic apparatus comprising a multilayer circuit board as claimed in claim 9.

12. The electronic apparatus comprising an electronic device as claimed in claim 10.
